(19) United States
(12) Patent Application Publication
(10) Pub. No.: US 2005/0269177 A1
(43) Pub. Date: Dec. 8, 2005

(54) Drive unit comprising a retarder

(76) Inventor: Klaus Vogelsang, Crailsheim (DE)

Correspondence Address: BAKER & DANIELS LLP;111 E. WAYNE STREET, SUITE 800, FORT WAYNE, IN, 46802, US

(21) Appl. No.: 10/527,489

(22) PCT Filed: Sep. 15, 2003
(86) PCT No.: PCT/EP03/10250

§ 371 Date: Apr. 21, 2005

(30) Foreign Application Priority Data
Sep. 13, 2002 (DE) 102 42 736.4

(51) Int. Cl. F16D 57/02

(52) U.S. Cl. 188/296

(57) ABSTRACT

The invention relates to a drive unit of a motor vehicle provided with a cooling circuit, said drive unit comprising a hydrodynamic retarder having a rotor vane wheel and a stator vane wheel, the hydrodynamic retarder being arranged in the vehicle cooling circuit and the working medium of the retarder being the vehicle cooling medium. The inventive drive unit is characterized in that means for removing a pre-determined quantity of working medium from the cooling circuit during the changeover from braking mode to non-braking mode, and for supplying a pre-determined quantity of working medium into the cooling circuit during the changeover from non-braking mode to braking mode, are connected to the cooling circuit.

The invention involves a drive unit, in particular, including the characteristics described in the preamble included of claim 1.

A retarder for the purpose of decreasing speed or rotational frequency is often integrated into vehicle drive systems or stationary systems. When used in motor vehicles or in systems with highly changing operations due to filling and draining the blading working cycle, the retarder is activated and de-activated by means of an operating fluid.

The stationary or mobile units, as, for instance, motor vehicles, into which the above-mentioned drive units are integrated, usually have additional aggregates that require cooling. This includes, for instance, motors, brakes, clutches, and gearboxes.

These additional aggregates could also have a cooling circuit in order to cool down the working medium. p A large number of patents introduced Retarders to us in which the working medium of the retarder is the cooling medium of the vehicle.

In this regard, reference could be made to
EP 0 716 996 A1
WO 98/15725
EP 0 885 351 B1
EP 0 932 539 B1

The disclosure content of these patents is completely included in the application at hand.

In order to keep the power loss of these retarders in non-braking mode at a low level, most of the working medium is drained from the workspace of the retarder in non-braking mode. During the changeover [from non-braking mode] to braking mode, in turn, the retarder is quickly filled with working medium. The disadvantage of this process is the fact that during the changeover from braking mode to non-braking mode, and from non-braking mode to braking mode, high-pressure impulses take place in the system which put stress on the individual component parts.

The invention has the objective to present a drive unit comprising a retarder that could be filled and drained, in particular a water retarder, specifically a secondary water retarder which does not have any pressure impulses during the changeover from braking mode to non-braking mode, or vice versa, or such pressure impulses are at least to a large extent decreased.

This objective is reached through a drive unit which includes the characteristics described in claim 1. The dependent claims describe particularly practical improvements of the invention.

According to a first embodiment of the invention, a connected damper cylinder is attached to the cooling circuit which removes a pre-determined quantity of working medium from the cooling circuit during the changeover from braking mode to non-braking mode, and which supplies a pre-determined working medium into the cooling circuit during the changeover from non-braking mode to braking mode. For this purpose, the supplied quantity of working medium, in particular, corresponds to the previously removed quantity of working medium.

According to a further development, the damper cylinder is connected at two places to the cooling circuit so that it works automatically.

According to an additional or alternative embodiment, a bypass section with a connected bypass valve has been provided in the cooling circuit which opens during the changeover from braking mode to non-braking mode and gives way to an additional line section which, at least temporarily, accepts a pre-determined quantity of working medium.

Subsequently, the invention shall be described in more detail by means of figures of various embodiments.

It is shown

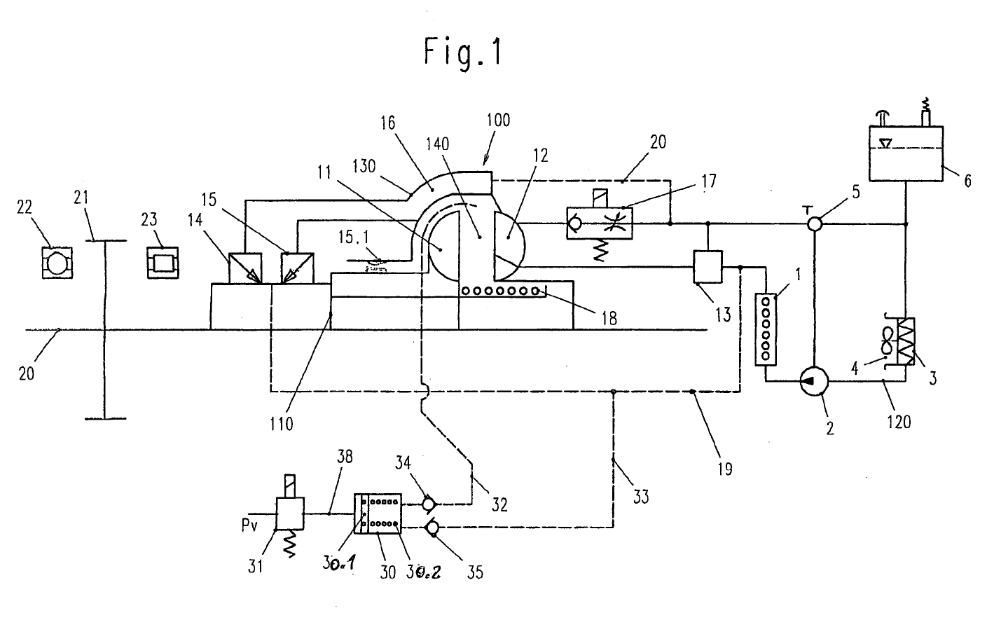

FIG. 1 a first embodiment of the invention;

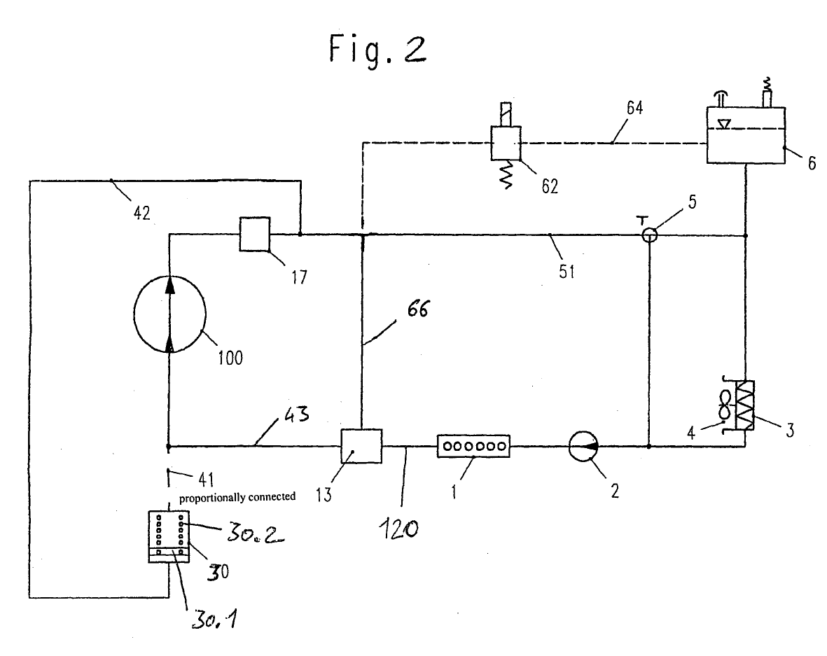

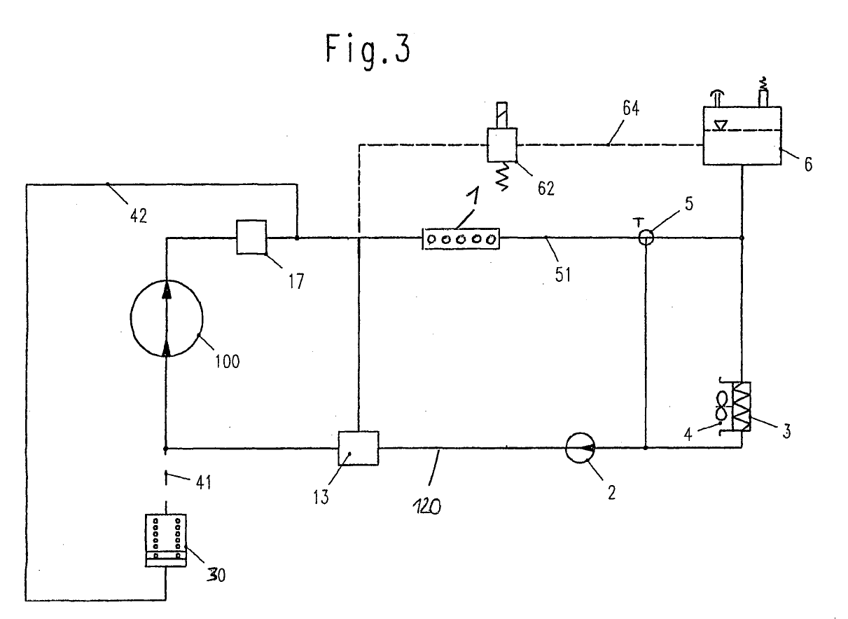

FIGS. 2 and 3 a second embodiment of the invention;

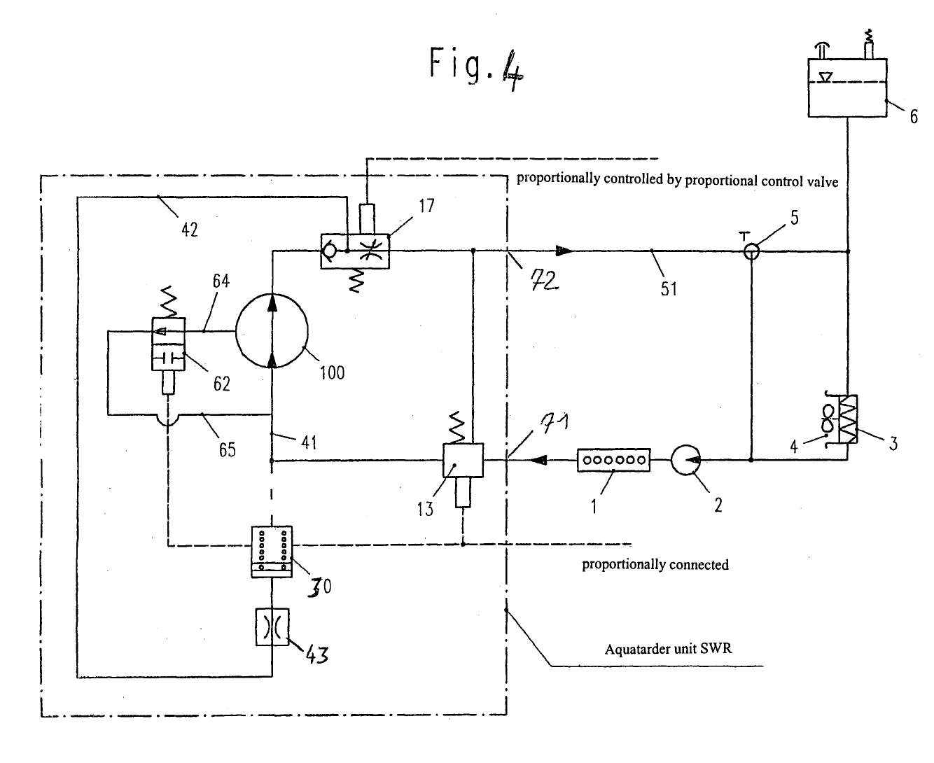

FIG. 4 a third embodiment of the invention.

In FIG. 1, a secondary retarder (100) is shown which is operated with the cooling medium of the vehicle. The retarder shown in FIG. 1 is marked by a low level of power loss.

According to a first method, the rotor vane wheel (11) is positioned on the rotor shaft (110) axially relocatable so that the rotor (11) could be brought into working position close to the stator (12) or into resting position with considerable distance to the stator (12) during the non-braking mode. In FIG. 1, the retarder is shown in resting position. With regard to the relocatibility of the rotor, reference is made to WO 98/35171.

The retarder shown in FIG. 1 comprises a rotor (11) which is supported, torque proof and in an overhung position, on a spinning shaft (110), the so-called retarder shaft which, in turn, is imbedded, for instance, in a gearbox. The shaft (110) with the bearings (22 and 23) is powered via a pinion (21) by the drive shaft of a gearbox, which is not displayed in the figure. By means of a helical tooth system, which is not displayed, the rotor (11) could be laterally moved on the shaft (110) so that the distance between rotor and stator could be adjusted. In non-braking mode, the spring (18) could adjust the rotor (11) into the displayed low-loss position, resulting in a maximum gap between rotor and stator (12). The retarder has a retarder housing (130) with an internal space (16). This internal space (16) is filled with cooling medium and acts as cooling jacket. The space between rotor (11) and stator (12) is referred to as workspace (140) and is filled with working medium. The hydrodynamic retarder is integrated into the cooling circuit (120) of the motor vehicle. Consequently, in the displayed embodiment of the retarder, the working medium of the retarder is also the cooling medium of the motor vehicle. In order to keep the idling losses at a minimum, the retarder has to be drained in non-braking mode. This draining would also include an emptying to a pre-determined remaining quantity of working medium, which practically would result in minimal power loss.

This draining process, which is mainly activated by the pumping action of the rotor (11), is basically controlled by the control valve (17).

In order to adjust the pressure impulse, which enters the cooling circuit (120) because of the fact that the quantity of working medium contained in the retarder during braking mode is drained relatively quickly into the remaining cooling circuit (120), a damper cylinder (30) has been provided. During the changeover from braking mode to non-braking mode, this damper cylinder (30) accepts a pre-determined quantity of working medium. Later, during the changeover from non-braking mode to braking mode, the pressure impulse, which occurs because of the fact that during the filling period the retarder removes relatively quickly a certain quantity of working medium from the remaining cooling circuit (120), is once again adjusted. It is adjusted by the fact that the quantity of working medium contained in the damper cylinder (30) is re-circulated into the cooling circuit (120).

The circuit of the damper cylinder, which has a piston (30.1) and a compression spring (30.2), is being adjusted via the pressure in the line (38). The pressure in the line (38), in turn, is being adjusted via the valve (31). This shows that the line (38) has a current-conducting connection to the side of the cylinder (30) which is opposite to the side of the cylinder (30) having the compression spring. As a result, the compression spring (30.2) presses the piston against the pressure in the line (38).

The check valves (34 and 35) in the lines (32 and 33) accomplish that, during the changeover from braking mode to non-braking mode, the working medium is basically removed from the workspace (140) of the retarder or the conduction branch behind the workspace. During the changeover from non-braking mode to braking mode, the working medium is re-circulated to the line (19) via the line (33).

In the embodiment shown in FIG. 1, the hydrodynamic retarder comprises three different seals. One of the seals is an axial face seal with absolute impermeability toward the outside—toward the atmosphere—and is constantly washed around in cooling fluid (14). Another seal (15) has to fulfill two sealing functions. During non-braking mode, the cooling fluid, which could constantly flow through the inside space (16) of the retarder housing via the line (19), is absolutely sealed in the direction of the rotor and stator; that is, in non-braking mode, the seal (15) accepts the sealing function. During braking mode, the split-ring seal (15.1) acts as non-contact labyrinth seal, and the cooling fluid flows through the seal (15) which, in this case, is not performing any sealing function. In this way, it is guaranteed that, during brake mode, the seal (14) is lowered to the pressure level of the closed cooling system.

The interior (16) is shaped in a way that it functions as heat dispensing cooling jacket of the retarder in which the cooler medium is supplied via the line (19) and drained via the line (20).

FIGS. 2 and 3 show alternative embodiments of the invention. These are characterized by the fact that the supply and removal of the working medium by means of the damper cylinder (30) takes place automatically, that is, exclusively dependent on pressures in the cooling circuit. Via the line (42), the damper cylinder transporting the working medium is connected to a place of high pressure behind the retarder (100) and the control valve (17) which controls the draining of the retarder (100) and, via the line (41), it is connected to a place of low pressure in front of the retarder (100) behind the reversing valve (13) transporting the pressure. During the changeover from braking mode to non-braking mode, the reversing valve (13) changes the working medium flow in such a way that the retarder (100) is no longer supplied with working medium via the line (43), but the entire working medium is directed via the bypass (66) around the conduction branch of the cooling circuit with the retarder (100). Accordingly, the pressure in the line (43) and, consequently, also in the line (41) connecting to the pressure decreases. The piston (30.1) of the damper cylinder (30) is pressed against the thrust force of the compression spring (30.2) and receives via the line (42) working medium from the cooling circuit (120). Consequently, the portion of working medium, which is removed from the retarder (100) during the process of draining, is “collected” in the damper cylinder (30), and the particular pressure impulse caused by the draining of the retarder is decreased.

During the subsequent changeover from non-braking mode to braking mode, the reversing valve switches the working medium flow once again to the line (43) in the direction of the retarder (100). As a result, the pressure in the line (43) and, consequently, also in the pressure line (41) connecting to the damper cylinder (30) increases. This increasing pressure together with the thrust force of the spring (30.2) presses the piston (30.1) of the damper cylinder (30) opposite to the static pressure from the line (42) and, consequently, pushes the quantity of working medium contained in the damper cylinder (30) back into the cooling circuit (120). As a result, at least partially, the pressure loss in the cooling circuit (120), which results from the process of filling the retarder (100), is adjusted.

The embodiment according to FIG. 3 basically corresponds to the embodiment according to FIG. 2. Corresponding component parts have the same reference numbers as in FIG. 2. One difference is the arrangement of the retarder circuit in the cooling circuit (120) of the vehicle. In FIG. 3, when the retarder is being connected, the branch of the cooling circuit with the retarder (100) is positioned between the cooling pump (2) and the motor (1). In FIG. 2, on the other hand, this circuit branch in the cooling circuit (120) was positioned behind the motor (1). As in the embodiment according to FIG. 2, a shutoff valve (62) is being designed which could be switched to opening position, as well as a pressure relief line (64) which is connected to the compensating reservoir (6). The pressure shutoff valve (62) is located in the pressure relief line (64). In case of high-pressure peaks, such as impulse impacts during the process of draining the retarder, it will be opened. Because of this additional measure, pressure peaks occurring in the cooling circuit during retarder operation or during the changeover from braking mode to non-braking mode could be further reduced. The pressure relief line (64) is directly connected to the compensating reservoir (6).

FIG. 4 shows a further development of the invention. The displayed wiring diagram shows measures that were taken in order to prevent to a large extent the occurrence of a pressure impulse in the system, in particular, in the line (51) during the changeover of the retarder from braking mode to non-braking mode. In addition, measures are displayed which could be performed additionally or alternatively in order to prevent the occurrence of a pressure impulse or spontaneous pressure loss during the changeover from non-braking mode to braking mode.

The measures mentioned first—prevention of disconnection impact—are basically epitomized by means of the pressure-connected valve (62) with the connected lines (64 and 65). With its end facing away from the valve (62), the line (64) is located in a high-pressure area of the cooling circuit. This could, for instance, be in the area of the working medium outlet of the retarder or at a draining channel, which is designed in the retarder housing. There could be, for instance, a pressure of 11 bar at the beginning of the non-braking mode. A further practical possibility of connection could result from the position between the displayed check valve and the adjustable choke of the control valve (17). There could be, for instance, a pressure of 30 bar.

With its end facing away from the valve (62), the line (64) is connected in a low-pressure area of the cooling circuit. Practically, there is a maximum pressure of 2 bar. The connection could, for instance, be arranged in the area of the inflow of the retarder (100), in particular, at a filling channel, which is arranged in the retarder.

Profitably, the control of the valve (62) takes place with the same control impulse with which also the valve (13) is controlled. In particular, both valves are being connected by means of a pressure impulse (p-connected). During the changeover from braking mode to non-braking mode, the valve (62) is changed from a closed position to an open position. This will result in a short circuit flow via the retarder (100), that is, working medium, in this case, the cooling medium of the vehicle flows from the high pressure area mentioned above via the lines (64 and 65) into the low pressure areas mentioned above. Consequently, a delayed discharge of the entire working medium, which had been received by means of the retarder or the connected pipelines during the braking mode, is being supplied into the line (51) since, as a result of the short circuit flow, a large quantity had been kept first of all in the area of the retarder (100). This prevents a pressure impulse in the line (51). The cooling circuit area between the valve (13) and the valve (17) via the retarder (100) and the lines connected to the retarder is being evenly drained.

A the same time, as in the previous embodiments, a damper cylinder has been designed which receives working medium during the changeover from braking mode to non-braking mode and which, in turn, removes working medium during the changeover from non-braking mode to braking mode. This shows that, in this embodiment, the line (42) carrying the working medium, which is connected on the opposite side of the compression spring in the damper cylinder (30, is connected with a high-pressure area between the check valve and the adjustable choke (43) of the control valve. In the line (42), a choke (43) has been connected so that, during the changeover from braking mode to non-braking mode, the removed quantity of working medium could be removed in a controlled way from the cooling circuit. At the same time, by means of this choke (43), the quantity of working medium of the damper cylinder (30) is supplied into the cooling circuit during the changeover from non-braking mode to braking mode.

In order to achieve an optimal power loss, that is, a power loss as little as possible, in non-braking mode, the control valve (17) is profitably designed in such a way that, during non-braking mode, it completely seals the cooling circuit of the vehicle (beginning with line 51) in non-braking mode toward the conduction branch of the retarder (100). The same applies to the valve (13) which, profitably, also in non-braking mode, completely seals the cooling circuit of the vehicle (beginning with the conduction branch in which the motor (1) is displayed) toward the line area in which the retarder (100) is located. In addition, during non-braking mode, the valve (13) is connected in such a way that the entire quantity of cooling fluid is directed via the line (66) into the line (51).

In order to prevent a make impulse, as indicated above, during the changeover from braking mode to non-braking mode, the valve (13) could be switched into intermediate position so that initially only part of the cooling medium is directed via the line (67) to the retarder (100) while another part continues being directed via the line (66) toward the line (51) and, consequently, remains in the cooling circuit without having to go through the retarder.

As further indicated in FIG. 4 by means of the dashed line, particular pre-determined component parts could be assembled into a water retarder unit (70).

One embodiment of this water retarder unit (70 designed in this invention comprises the retarder (100) and the means for adjusting pressure variations during the changeover from braking mode to non-braking mode and vice versa. In one specific embodiment, such means involve the displayed damper cylinder (30), particularly in connection with the choke (43), the control valve (17), and the reversing valve (13). In a particularly practical embodiment, the water retarder unit (70) also comprises the pressure relief lines (64 and 65) including the intermediary pressure shutoff valve (62). Certainly, the water retarder unit (70) has been equipped with connection points for pressure control or pressure regulation, for instance, for pressure connection of the valve (13) and pressure regulation of the valve (17). Also the other lines being surrounded by the dashed line are practically integrated in the water retarder unit (70) so that they could be connected to the cooling circuit of a motor vehicle as a flexible standard unit. For this purpose, the water retarder unit (70), in particular, are equipped with only one connection (71) for supplying cooling medium and only one connection (71) for removing cooling medium.

1. Drive unit of a vehicle with a vehicle cooling circuit, consisting of a hydrodynamic retarder with a rotor vane wheel and a stator vane wheel, in which the hydrodynamic retarder is located in the vehicle cooling circuit and the working medium of the retarder corresponds to the vehicle cooling medium characterized by the fact that means are connected to the cooling circuit for the purpose of removing a pre-determined quantity of working medium from the cooling circuit during the changeover from braking mode to non-braking mode, and for the purpose of supplying a pre-determined quantity of working medium into the cooling circuit during the changeover from non-braking mode to braking mode.

2. Drive unit according to claim 1, characterized by the fact that, as a means for adjusting pressure variations, a connected damper cylinder is attached to the cooling circuit in such a way that, during the changeover from braking mode to non-braking mode, a pre-determined quantity of working medium is removed from the cooling circuit and, during the changeover from non-braking mode to braking mode, a pre-determined working medium is supplied into the cooling circuit, whereby the changeover takes place controlled and automatically.

3. Drive unit according to claim 2, characterized by the fact that the damper cylinder comprises a piston which is on one side connected pressure-conducting to the cooling circuit in front of the workspaces of the retarder and which additionally is pressure-loaded by means of a compression spring in the damper cylinder and which, on the other side, is connected to the cooling circuit behind the workspace of the retarder via a line.

4. Drive unit according to claim 1, characterized by the fact that a pressure relief line is connected to a pressure shutoff valve at the cooling circuit and/or the retarder, whereby the pressure shutoff valve is positioned in the pressure relief line in such a controlled way that it is opened during the changeover of the retarder from braking mode to non-braking mode.

5. Drive unit according to claim 1, characterized by the fact that, during braking mode, the pressure relief line is connected to the front of the retarder with one end at a place of low pressure in flow direction and with the other end at a place of high pressure to the retarder or behind the retarder, whereby the pressure at the place of low pressure, in particular, amounts to a maximum of 2 bar and the pressure at the place of high pressure amounts, in particular, to between 11 and 30 bar.

6. Drive unit according to claim 1, characterized by the fact that the drive unit has a motor and a gearbox, and that the retarder is a secondary retarder which is located in force flow direction behind the gearbox.

7. Retarder unit, comprising a hydrodynamic retarder with a rotor and a stator, whereby the hydrodynamic retarder has a vehicle cooling medium as working medium, and the retarder unit has a connection for the purpose of supplying cooling medium and a connection for the purpose of removing cooling medium, characterized by the fact that the retarder unit has means for the purpose of removing a pre-determined quantity of working medium during the changeover from braking mode to non-braking mode, and for the purpose of supplying a pre-determined quantity of working medium during the changeover from non-braking mode to braking mode.

8. Retarder unit according to claim 7, characterized by the fact that the means for the purpose of removing and supplying a pre-determined quantity of working medium comprise a damper cylinder which has a piston which on one side is connected current-conducting to the cooling circuit in flow direction behind the retarder via a line at a place of high pressure in the retarder unit. On its opposite side, it is connected pressure-conducting in front of the retarder via a line at a place of low pressure in the retarder unit.

9. Retarder unit according to claim 7, characterized by the fact that the retarder unit also has a shutoff valve in a pressure relief line, whereby the pressure relief line is on one end connected at a place of high pressure of the cooling circuit in flow direction behind the retarder or at the retarder. At its other end, the pressure relief line is connected at a place of low pressure of the cooling circuit in flow direction in front of the retarder.

10. Retarder unit according to claim 7, characterized by the fact that the line, at the end opposite of the damping cylinder, is connected to a control valve, and that the retarder unit also has a reversing valve in flow direction behind the connection for the purpose of supplying cooling medium and in front of the retarder which is developed in such a way that in pre-determined switching positions cooling medium is directed around the retarder by means of the retarder or by means of a bypass, and that in that way the control valve, the pressure shutoff valve, and the reversing valve will be pressure-load connected or controlled, whereby the retarder unit has been equipped with attached pressure-control connections.

11. Retarder unit according to claim 10, characterized by the fact that the reversing valve and the control valve are designed in such a way that they are completely sealed in the pre-determined switching position in which, by means of the bypass, cooling medium is being directed around the retarder in the direction of the retarder.

12. Drive unit according to claim 2, characterized by the fact that a pressure relief line is connected to a pressure shutoff valve at the cooling circuit and/or the retarder, whereby the pressure shutoff valve is positioned in the pressure relief line in such a controlled way that it is opened during the changeover of the retarder from braking mode to non-braking mode.

13. Drive unit according to claim 3, characterized by the fact that a pressure relief line is connected to a pressure shutoff valve at the cooling circuit and/or the retarder, whereby the pressure shutoff valve is positioned in the pressure relief line in such a controlled way that it is opened during the changeover of the retarder from braking mode to non-braking mode.

14. Drive unit according to claim 2, characterized by the fact that, during braking mode, the pressure relief line is connected to the front of the retarder with one end at a place of low pressure in flow direction and with the other end at a place of high pressure to the retarder or behind the retarder, whereby the pressure at the place of low pressure, in particular, amounts to a maximum of 2 bar and the pressure at the place of high pressure amounts, in particular, to between 11 and 30 bar.

15. Drive unit according to claim 3, characterized by the fact that, during braking mode, the pressure relief line is connected to the front of the retarder with one end at a place of low pressure in flow direction and with the other end at a place of high pressure to the retarder or behind the retarder, whereby the pressure at the place of low pressure, in particular, amounts to a maximum of 2 bar and the pressure at the place of high pressure amounts, in particular, to between 11 and 30 bar.

16. Drive unit according to claim 4, characterized by the fact that, during braking mode, the pressure relief line is connected to the front of the retarder with one end at a place of low pressure in flow direction and with the other end at a place of high pressure to the retarder or behind the retarder, whereby the pressure at the place of low pressure, in particular, amounts to a maximum of 2 bar and the pressure at the place of high pressure amounts, in particular, to between 11 and 30 bar.

17. Drive unit according to claim 2, characterized by the fact that the drive unit has a motor and a gearbox, and that the retarder is a secondary retarder which is located in force flow direction behind the gearbox.

18. Drive unit according to claim 3, characterized by the fact that the drive unit has a motor and a gearbox, and that the retarder is a secondary retarder which is located in force flow direction behind the gearbox.

19. Drive unit according to claim 4, characterized by the fact that the drive unit has a motor and a gearbox, and that the retarder is a secondary retarder which is located in force flow direction behind the gearbox.

20. Drive unit according to claim 5, characterized by the fact that the drive unit has a motor and a gearbox, and that the retarder is a secondary retarder which is located in force flow direction behind the gearbox.
